(19) United States
(12) Patent Application Publication
(10) Pub. No.: US 2018/0239352 A1
(43) Pub. Date: Aug. 23, 2018

(54) SYSTEM AND METHOD FOR OPERATING VEHICLES AT DIFFERENT DEGREES OF AUTOMATION

(71) Applicant: Faraday&Future Inc., Gardena, CA (US)

(72) Inventors: Yizhou Wang, San Jose, CA (US); Shiying Zhou, Albany, CA (US); Chongyu Wang, San Jose, CA (US); Kai Ni, Sammamish, WA (US)

(21) Appl. No.: 15/691,618

(22) Filed: Aug. 30, 2017

Related U.S. Application Data
(60) Provisional application No. 62/382,144, filed on Aug. 31, 2016.

(51) Int. Cl. G05D 1/00; B60W 30/182; B60W 50/14

(52) U.S. Cl. CPC G05D 1/0061; B60W 30/182; G05D 2201/0213; G05D 1/0088; B60W 50/14

(57) ABSTRACT

A system that performs a method is disclosed. The system operates a vehicle in a first automation level corresponding to a first plurality of modes for operating the vehicle. The first plurality of modes comprises logic for performing automated driving operations, wherein the first automation level is associated with a first logic for transitioning between the first plurality of modes. While operating the vehicle in the first automation level, the system determines that automation level change criteria for transitioning from the first automation level to a second automation level are satisfied. In response to the determination, the system operates the vehicle in the second automation level corresponding to a second plurality of modes for operating the vehicle. The second plurality of modes comprises logic for performing automated driving operations, wherein the second automation level is associated with a second logic for transitioning between the second plurality of modes.

### CROSS-REFERENCE TO RELATED APPLICATIONS

This application claims the benefit of U.S. Provisional Application No. 62/382,144, filed Aug. 31, 2016, the entirety of which is hereby incorporated by reference.

### FIELD OF THE DISCLOSURE

The various embodiments of the present invention relate generally to operating an autonomous vehicle at different automation levels and, more particularly, to transitioning between automation levels in accordance with conditions in the vehicle's surroundings.

### BACKGROUND OF THE DISCLOSURE

Vehicles, especially automobiles, are increasingly including autonomous driving technologies. Many of the autonomous driving technologies implement different levels of vehicle automation. Moreover, existing driving solutions are unable to address every possible circumstances encountered by vehicles operating autonomously. Therefore, a solution to enable a vehicle to perform automatic driving operations under various circumstances at different levels of automation is desirable.

### SUMMARY OF THE DISCLOSURE

Examples of the disclosure are directed to operating a vehicle at different automation levels depending on the characteristics of the vehicle's surroundings and driver preferences, which can be preset or be specified in real time. A vehicle in accordance with an embodiment of the present invention can navigate itself at a fully automated level, semi-automated level, assisted level, drive-by-wire level, or allow the driver to manually take over driving operations depending on the characteristics of the vehicle's surroundings and driver preferences. Additionally, the different levels of automation can be composed of a plurality of modes for performing automated driving operations.

### BRIEF DESCRIPTION OF THE DRAWINGS

FIG. 1 illustrates an exemplary process for safely automating vehicle operations according to examples of the disclosure.

FIG. 2 illustrates exemplary block diagram 200 including various automated driving levels at which a vehicle can operate according to examples of the disclosure.

FIG. 3 illustrates an exemplary block diagram of modes that perform automated driving operations according to examples of the disclosure.

FIG. 4 illustrates an exemplary block diagram of modes that perform automated driving operations according to examples of the disclosure.

FIG. 5 illustrates an exemplary block diagram of modes that perform automated driving operations according to examples of the disclosure.

FIG. 6 illustrates an exemplary process for operating a vehicle electronically according to examples of the disclosure.

FIG. 7 illustrates an exemplary process for controlling when to exit vehicle automation according to examples of the disclosure.

FIG. 8 illustrates an exemplary system block diagram of a vehicle control system according to examples of the disclosure.

### DETAILED DESCRIPTION

In the following description of examples, references are made to the accompanying drawings that form a part hereof, and in which it is shown by way of illustration specific examples that can be practiced. It is to be understood that other examples can be used and structural changes can be made without departing from the scope of the disclosed examples. Further, in the context of this disclosure, “autonomous driving” (or the like) can refer to either autonomous driving, partially autonomous driving, and/or driver assistance systems.

Some vehicles, such as automobiles, may include technology for performing automated driving operations. Additionally, vehicles include various sensors for detecting and gathering information about the vehicles' surroundings. However, many of the autonomous driving technologies implement different levels of vehicle automation and these existing driving solutions are unable to address all possible circumstances encountered by vehicles operating autonomously. Examples of the disclosure are directed to using automated driving technologies for performing autonomous driving operations at different levels of autonomy based on user preferences and characteristics about the vehicle's surroundings. A vehicle can transition between levels of automation in response to determining that certain conditions exist in the vehicle's surroundings and/or based on user input (e.g., preferences). Once operating at a given automation level, vehicle operations can be controlled by logic and procedures associated with that automation level, which can be tailored to certain conditions (e.g., characteristics about the vehicle's surroundings). In this way, the vehicle can easily and effectively address many different conditions encountered by the vehicle.

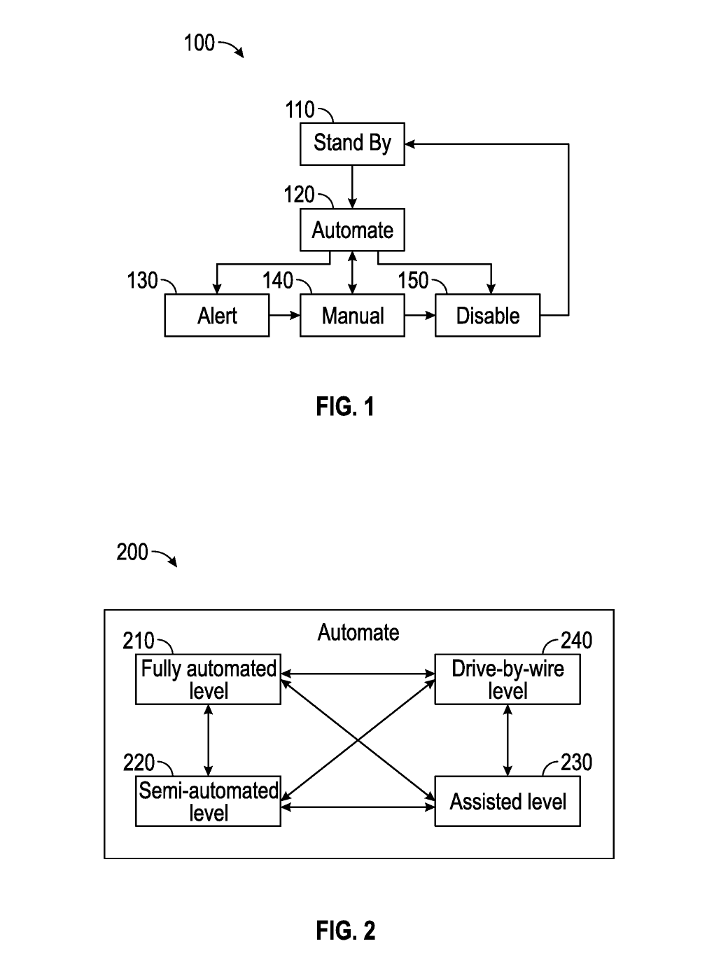

FIG. 1 illustrates an exemplary process 100 for safely automating vehicle operations according to examples of the disclosure.

At step 110, process 100 runs a systems check to verify that the vehicle is functioning properly. This may include checking all of the vehicle's sensors to ensure that nothing on the vehicle is malfunctioning and/or that it is safe to autonomously operate the vehicle. For example, the vehicle may verify that the location of the vehicle provided by a Global Navigation Satellite System (GNSS) (e.g., Global Positioning System (GPS), BeiDou, Galileo, etc.) is initialized properly, the weather conditions are safe for autonomous driving, the vehicle's tires have adequate air pressure (e.g., are not punctured), all vehicle fluids are at adequate levels, and/or the brakes are not worn out by processing information from the vehicle's sensors. The vehicle can also verify that all of the vehicle's doors are closed and/or that all of the passengers are wearing seatbelts. In some examples, process 100 can notify the driver or any other third party if something on the vehicle is malfunctioning or if it is unsafe to autonomously operate the vehicle. In that instance, process 100 can remain at step 110 until it is safe to operate the vehicle autonomously, the vehicle is shut down, or the driver takes over driving operations.

At step 120, process 100 automates vehicle driving operations at a user-desired level of autonomy (e.g., fully automated, semi-automated, assisted driving, and/or drive-by-wire as described in detail below). For example, process 100 can operate the vehicle at a fully automated level without user input (e.g., other than designating the vehicle's destination). Process 100 can also operate the vehicle at a semi-automated level where the user activates discrete automated vehicle operations such as lane-following (e.g., to stay within the vehicle's current lane while keeping up with the flow of traffic), passing another vehicle on the road, changing lanes, parking, pulling over, and/or any other discrete driving operation or maneuver. Additionally, process 100 can operate the vehicle at an assisted level that enables basic assisted-driving operations such as automatic speed control (e.g., cruise control and/or assisted cruise control functionalities), automatic lane keeping (e.g., automatically staying within the vehicle's lane without automating the vehicle's speed), and/or automatic parallel parking. Lastly, process 100 can operate the vehicle at a drive-by-wire level where the user navigates the vehicle electronically (e.g., controls vehicle acceleration, deceleration, and turning electronically). In some examples, the vehicle can display the current automation level and/or all of the available automation levels. Process 100 can also automate vehicle operations at the automation levels defined by the U.S. Department of Transportation's National Highway Traffic Safety Administration (NHTSA). (See http://www.nhtsa.gov/About+NHTSA/Press+Releases/U.S.+Department+of+Transportation+Rel eases+Policy+on+Automated+Vehicle+Development.)

At step 130, process 100 alerts the driver or any designated third party that the vehicle must exit and/or is exiting automated driving operations and the driver or any designated third party must manually take over driving operations. In some examples, the vehicle may provide a haptic indicator (e.g., one or more vibrating seats and/or seatbelts). In some examples, the vehicle can provide a visual alert through the vehicle's one or more display systems (e.g., control panel, entertainment system, heads up display system, or infotainment system). In some examples, the alert can include activating visual and/or audio indicators. Visual indicators can include one or more of a headlight, a hazard light, a smog light, or any light source on the outside or the inside of the vehicle. The audio indicators can include one or more of a horn, a speaker, an alarm system, and/or any other sound source in the vehicle. In some examples, the visual and/or audio indicators can intensify (e.g., get louder or increase frequency) until the driver manually takes over driving operations. In some examples, the alert can be a phone call, text message, email, or any form of electronic or audible/visual communication to an electronic device associated with the vehicle's owner, driver, passenger(s), or any third party (e.g., smartphone and/or other electronic device). The designated third party can be the vehicle's owner, a call center, a 911 operator, and/or any other third party. In some examples, the designated third party can be located in the vehicle or can be located remotely from the vehicle.

At step 140, process 100 allows the driver to manually take over driving operations. Process 100 can allow the driver to take over driving operations after performing the alert operation in step 130 or from any automation level at step 120 (e.g., fully automated, semi-automated, assisted driving, and/or drive-by-wire). For example, the vehicle can be operating at the fully automated level (e.g., autonomously navigating to its destination) when the driver decides to manually take over driving operations. As another example, the vehicle can be operating in the semi-automated level when the vehicle enters an area with heavy fog (and/or any other severe weather conditions), requiring the driver to manually take over driver operations. In some examples, process 100 can notify the driver or any designated third party that the process exited the automated driving mode and entered step 140. In some examples, process 100 can return to operating the vehicle at the same or a different automated level (e.g., return to step 120) from step 140. For example, the driver can manually take over driving operations while navigating through the drive-thru lane of a fast food restaurant (e.g., manually operate the vehicle at step 140) and subsequently request that process 100 autonomously drive the vehicle home under the fully automated level at step 120.

At step 150, process 100 can disable the vehicle by shutting it down (e.g., turning off the engine) or by idling the vehicle. In some examples, the driver can request that process 100 disable the vehicle at step 140 or at any automated level at step 120 (e.g., the driver manually requests that process 100 transition to step 150 to disable the vehicle). In some examples, process 100 can automatically transition from step 120 to step 150 to disable the vehicle (e.g., as discussed in further detail below). For example, the vehicle can autonomously navigate through a route (e.g., operating driving operations at the fully automated level) until the vehicle reaches its destination. Upon reaching the destination, the vehicle can then automatically (e.g., without user input) park itself at the destination at step 120 and subsequently disable itself at step 150. In some examples, step 150 can include a safe pull over function (e.g., as described in further detail below) to ensure that the vehicle is not on a road and is not moving before the vehicle is disabled.

FIG. 2 illustrates exemplary block diagram 200 including various automated driving levels (e.g., automated driving states) at which a vehicle can operate according to examples of the disclosure. FIG. 2 can implement automate step120 of process 100 (e.g., as described above with reference to step 120 of FIG. 1 above). Each of automated levels 210, 220, 230, and 240 can correspond to a plurality of modes for operating a vehicle. In turn, the plurality of modes can correspond to set of logic or procedures for performing automated driving operations while the vehicle is operating in a respective automated driving level (as described in further detail below). In some examples, each of automated driving levels 210, 220, 230, and 240 can have a set of logic or procedures for transitioning between the plurality of modes associated with that automation level (as described in further detail below). The set of logic or procedures for transitioning between the plurality of modes within an automation level can be different and/or a subset from another automation level. The vehicle can transition between any automation level while process 100 is at automate step 120 (e.g., as described above with reference to FIG. 1). In some examples, the transitions between automated levels 210, 220, 230, and 240 can be manual (e.g., manually triggered by the driver). For example, the vehicle can operate at an assisted level 230 (e.g., a driver navigating a vehicle with the cruise control activated) and the driver can manually trigger the transition for the vehicle to operate at fully automated level 210. In another example, the driver can be operating the vehicle in drive-by-wire level 240 and the driver can trigger the transition to the fully automated level 210 so that the vehicle autonomously (e.g., without any further user input) navigates itself to a desired destination. In some examples, the vehicle can be configured to ensure that a manually triggered transition is intentional by allowing the driver to only manually trigger a transition between automated levels when the vehicle is not moving (e.g., at a stop sign, traffic light, etc.) and/or when the vehicle is not turning (e.g., driving in a straight light). In some examples, the vehicle can be configured to require the driver to press two or more buttons at once or in a sequence, press one button and confirm the transition, have the driver take his/her hands off of the steering wheel, and/or require any other sequence that can help ensure the triggered transition was intentional.

In some examples, possible transitions between automated levels 210, 220, 230, and 240 can be automatically detected. For example, the vehicle can be operating in the drive-by-wire level 240 with the driver electronically controlling the speed and steering of the vehicle when the vehicle uses its localization systems (e.g., GPS, radar, LIDAR, and/or camera systems) and map information to determine that the current road does not have any traffic lights and/or does not curve for a threshold distance (e.g., 3 or more miles) and automatically prompts the driver to transition to a higher level of autonomy (e.g., any of automated level 210, 220, or 230). For another example, the vehicle can be operating at semi-automated level 220 when the vehicle uses its sensors (e.g., GPS, radar, LIDAR, and/or camera systems) and map information to detect heavy pedestrian activity around a school zone or a park and automatically prompts the driver to transition to a lower level of autonomy (e.g., automated driving level 230 or 240). In some examples, the prompt can be a visual, haptic, and/or audio notification to the driver of the possible transition. In some examples, the notification can be on any of the vehicle's display system(s) (e.g., the control, entertainment, infotainment, and/or heads up display system(s)), a smartphone, or any other electronic device with a display. In some examples, the vehicle can provide an audible notification through the vehicle's speaker(s) or any other sound source in the vehicle. In some examples, the notification can be a phone call, text message, email, or any form of electronic or audible/visual communication to an electronic device. In some examples, the driver can confirm or reject the transition to a different automated level through a control system such as a button, a touch screen, a voice command, a computer, a smartphone, or any device or system that allows user input to be entered.

In some examples, the transitions between automated levels 210, 220, 230, and 240 can be automatic. In this way, the examples described above can transition between automated levels without input from the driver. For example, the vehicle can be operating at semi-automated level 220 when the vehicle uses its sensors (e.g., GPS, radar, LIDAR, and/or camera systems) and map information to detect that it is entering a freeway and the vehicle automatically transitions to fully automated level 210. The vehicle can then automatically transition back to operating at semi-automated level 220 or to any other lower level of autonomy (e.g., automated driving level 230 or 240) when the vehicle uses its sensors and map information to detect that it is exiting the freeway. In another example, the vehicle can be operating at assisted level 230 when the vehicle uses its sensors and map information to detect that it is entering a parking lot and transitions to drive-by-wire level 240. In some examples, the vehicle can transition to fully automated level 210 when entering an automated driving lane, automated driving road, and/or any other designated automated driving area. In some examples, the driver can set preferences for under what circumstances to operate the vehicle at each of automated levels 210, 220, 230, and 240. For example, the driver can set preferences to operate the vehicle at fully automated level 210 on all freeways, on particular freeways, and/or on particular freeways at particular times, to operate the vehicle at drive-by-wire level 240 at all parking lots and/or particular parking lots, to operate the vehicle at assisted level 230 on particular roads, highways, and/or particular stretches of roads and/or highways, or to operate the vehicle at any desired automated level for any particular set of circumstances (e.g., location, time, traffic, weather, and/or any other driving conditions).

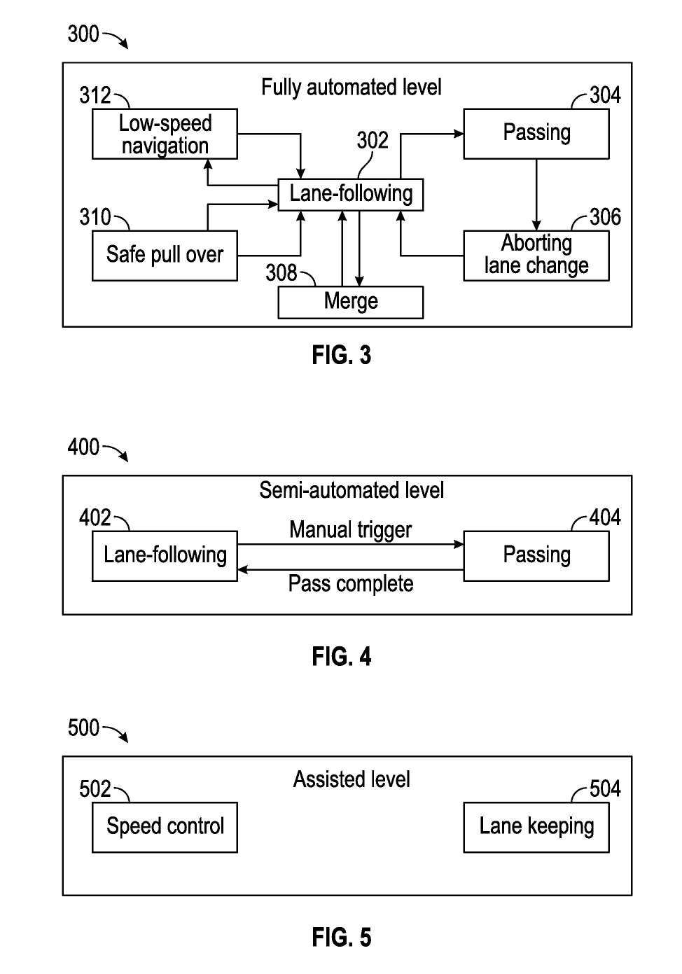

FIG. 3 illustrates an exemplary block diagram of modes that perform automated driving operations according to examples of the disclosure. Each of modes 302, 304, 306, 308, 310, and 312 correspond to a set of driving logic or procedures for controlling the vehicle at the fully automated level (e.g., as described above with reference to FIGS. 1-2). For example, while the vehicle is operating in lane-following mode 302, the vehicle can operate according to a first set of driving logic or procedures to stay within the current driving lane and along a driving route (e.g., make any necessary turns along the driving route). Under the lane-following mode, the vehicle can automatically (e.g., without user input) control its own speed and steering. In some examples, the vehicle can determine a driving route to a destination entered by the driver in lane-following mode 302 (e.g., by processing GPS location information and/or map information). This route planning can include automated spiral fitting (e.g., smoothing out the route trajectory facilitate steering). In some examples, route planning and automated spiral fitting can be incorporated into any mode described herein. In some examples, the lane-following mode can couple cruise control (or adaptive cruise control) functionality with vehicle navigation functionality (e.g., GPS location information and/or map information). In this way, the vehicle can autonomously navigate a driving route while automatically adjusting its speed to maintain a safe distance from other vehicles, pedestrians, or objects. The vehicle can also monitor its surroundings using any number of sensors and information sources, such as ultrasonic sensors, laser sensors, radar sensors, optical cameras, LIDAR sensors, any other sensors that can be used to detect one or more characteristics about the vehicle's surroundings, and external sources of information, such as real time information about the traffic in the vehicle's surroundings (or about the traffic on the vehicle's route) received from an Internet connection to the vehicle. In some examples, each mode can be associated with criteria for transitioning out of that mode, and/or criteria for transitioning into that mode. For example, mode 302 can be associated with a first set of criteria for transitioning out of mode 302 (e.g., criteria that is satisfied when information about the vehicle's surroundings indicates that the vehicle should not remain in mode 302), such that if, while operating in mode 302, the vehicle determines that the first set of criteria is satisfied, it automatically (e.g., without driver input) initiates operations to transition away from operating in mode 302. Additionally, mode 310, for example, can be associated with a second set of criteria for transitioning into mode 310 (e.g., criteria that is satisfied when information about the vehicle's surroundings indicates that the vehicle should transition into mode 310), such that if, in response to the vehicle determining that a mode change is warranted, the vehicle determines that the second set of criteria is satisfied, it automatically (e.g., without driver input) initiates operations to transition into mode 310. Other modes can similarly be associated with criteria for transitioning out of those modes, and criteria for transitioning into those modes at the fully automated level (e.g., as described above with reference to FIGS. 1-2). It should be understood that while transitioning from modes can occur without driver input, driver input can be used to transition between modes. Driver input may include many different inputs, including, but not limited to: pressing a button (a physical button or one on a display and/or touch screen), using a voice command, using a wireless device such as a smartphone, or a combination of such inputs. In some embodiments, driver input may include two or more actions, such as pressing two buttons, and/or pressing one button and confirming that the button was meant to be pressed. Herein, the term button is meant to be inclusive and may include, but is not limited to: one or more portions of a steering when, one or more portions of a touch screen, a navigational map, a portion of a center console, one or more foot pedals, etc.

In some examples, one or more of the modes may not be associated with criteria for transitioning out of those modes. Instead, while the vehicle is operating in a particular mode, it may continuously or periodically monitor conditions in its surroundings. Upon determining that the conditions in its surroundings satisfy criteria for transitioning into another mode (rather than criteria for transitioning out of the particular mode), the vehicle can both transition out of the particular mode and transition into the other mode in accordance with the satisfaction of the criteria for transitioning into the other mode. In some examples, a given set of conditions in the vehicle's surroundings will only correspond to a single mode (e.g., the given set of conditions trigger a determination that the vehicle should transition into a single particular mode), while in some examples, a given set of conditions in the vehicle's surroundings may correspond to more than one mode (e.g., the given set of conditions trigger a determination that the vehicle should transition into multiple candidate modes). In such examples, the vehicle can transition to a respective mode of the multiple candidate modes based on a predefined priority ordering of the modes (e.g., a predefined hierarchy of modes, such that the vehicle transitions to the mode with the highest position in the mode hierarchy of the multiple candidate modes).

In some examples, lane-following mode 302 can be the default driving mode in which the vehicle can initially operate when process 100 enters automate step 120 (e.g., as described above with reference to FIG. 1). As described above, lane-following mode 302 can handle route planning and route navigation (e.g., making any necessary stops and turns) while safely avoiding other vehicles, pedestrians, and/or objects. The vehicle can also automatically detect or be aware of traffic signs and/or traffic lights along the driving route and can react accordingly.

Passing mode 304 can correspond to a mode to which the vehicle can transition if conditions in the vehicle's surroundings dictate that the vehicle should pass another vehicle in the same driving lane. For example, if the vehicle determines that another vehicle in front of it is driving significantly below the speed limit (e.g., 5 miles per hour or more below the limit) or is slowing down, and the flow of traffic in another adjacent lane is faster than the speed of the other vehicle, the vehicle can automatically transition from mode 302 to mode 304. In some examples, passing mode 304 can simply cause the vehicle to change lanes, and not necessarily pass the other vehicle. The logic or procedures associated with mode 304 can be specific to mode 304 to ensure that successful passing or lane changing is completed. The vehicle can operate in mode 304 until the criteria for transitioning back into mode 302 (or the criteria for transitioning into another mode) are satisfied. In some examples, the vehicle must transition back into mode 302 before being able to transition into another mode (e.g., all mode changes are between mode 302 and another mode). In some examples, the vehicle is able to transition from any driving mode into any other driving mode without first needing to transition to mode 302. The above-described mode transition details can apply analogously to other driving modes described below, but will not be repeated for brevity.

Aborting lane change 306 can correspond to a cautionary mode into which the vehicle can automatically transition if conditions in the vehicle's surroundings dictate that the vehicle should abort lane change (or passing) procedures. For example, if the vehicle determines that a vehicle or an object has quickly and/or unexpectedly moved into the vehicle's path (e.g., a speeding vehicle in the adjacent lane), and poses a risk of colliding with the vehicle (e.g., the vehicle or object is within a threshold distance of the vehicle), the vehicle can transition into mode 306. The logic or procedures in mode 306 can be specific to mode 306 for avoiding a collision with the vehicle or object. For example, while in mode 306, the vehicle can be prepared to return to (or stay within) the current driving lane, and can increase a confidence factor in its rear sensor information (e.g., increase the weight given to information received from sensors for detecting conditions in the vehicle's rear surroundings when making various autonomous driving determinations). In this way, the vehicle can navigate back into (or stay within) the current driving lane while maintaining a safe distance (e.g., greater than a predetermined distance) from a trailing vehicle, so as to avoid a collision with the trailing vehicle as well. The vehicle can transition out of mode 306 in response to determining that conditions in its surroundings indicate that it is safe to do so (e.g., can transition back into mode 302 in response to determining that the vehicle will not collide with the vehicle or object).

Merge mode 308 can correspond to a driving mode into which the vehicle can automatically transition if the vehicle determines that it must merge into traffic (e.g., at a highway on-ramp, at a yield sign, into a rotunda, or any other instance that requires the vehicle to merge with another lane). The logic and procedures in mode 308 can be specific to mode 308 for safely merging into traffic or another lane. For example, while in mode 308, the vehicle can slow down, stop, or speed up and be prepared to make quick changes to its driving speed (e.g., with its brakes or its accelerator) or steering to safely merge into traffic. The vehicle can transition out of mode 308 in response to determining that it successfully merged into traffic (e.g., can transition back into mode 302).

Safe pull over mode 310 can correspond to a driving mode into which the vehicle can automatically transition if the vehicle determines that it must pull over after detecting a flat tire, engine trouble, a faulty sensor, or any other malfunction. The vehicle can also transition into mode 310 to allow an emergency vehicle (e.g., a police car, a fire truck, or an ambulance) to pass. The logic and procedures in mode 310 can be specific to mode 310 for safely pulling over. For example, while in mode 310, the vehicle can focus its sensors on the conditions on the vehicle's right when the vehicle is pulling over to the right side of the road to identify a path to move over to the right side of the road that is clear of obstacles. The vehicle can follow the identified path while monitoring other objects or vehicles to the vehicle's right to avoid collisions with those objects or vehicles. In this way, the vehicle can quickly and safely pull over. In some examples, the safe pull over mode 310 can be incorporated into step 130 and/or step 150 of process 100 (e.g., as described above with reference to FIG. 1 above). The vehicle can transition out of mode 310 in response to determining that the vehicle safely pulled over (e.g., can transition back into mode 302).

Low speed navigation mode 312 can correspond to a driving mode into which the vehicle can automatically transition if the vehicle determines that it must navigate at a low speed (e.g., through traffic, a parking lot, a school zone, a narrow driveway, around a stalled vehicle or vehicle(s) involved in an accident, or any other situation that would require the vehicle to travel at a low speed). The logic and procedures in mode 312 can be specific to mode 312 for navigating the vehicle below a speed threshold (e.g., 20 miles per hour or less). For example, while in mode 312, the vehicle can automatically navigate itself along a driving path composed of a series of waypoints. In additional longitudinal and latitudinal coordinates, these waypoints can each have a corresponding speed and heading for the vehicle to follow. In some examples, the vehicle can generate the waypoint path information based on location, traffic, or any other relevant information received by the vehicle's sensors or from an Internet connection to the vehicle. In some examples, mode 312 can ignore road markings (e.g., lane markings, parking spot markings, and crosswalk markings). In some examples, the vehicle can focus its sensors on the area immediately surrounding the vehicle because of the vehicle's slow speed. In this way, the vehicle can safely navigate itself through narrow spaces. The vehicle can transition out of mode 312 in response to determining that the need to travel at a low speed has passed (e.g., can transition back to mode 302).

The modes illustrated in FIG. 3 and described above are exemplary only, and it is understood that additional or alternative driving modes can be employed. For example, the vehicle can have access to a mode for platooning (e.g., driving in line and/or communicating with other vehicles to conserve resources). The vehicle can automatically enter this driving mode when it determines that other vehicles are traveling along the same route for a threshold distance (e.g., 5 or more miles). The logic or procedures in this mode can be specific to this mode for leading, entering, following, and exiting a platoon. For example, while in this mode, the vehicle can focus on data from its front and back sensors to maintain a safe distance from other vehicles in the platoon. In this way, the vehicle can safely follow and lead other vehicles in a platoon. In some examples, the platooning mode can include functionality to communicate information (e.g., traffic information, vehicle information, or map information with other vehicles in the platoon to coordinate routes, vehicle movements, speed, etc. through Internet, cellular, or any other wireless communication channels. In this way, the vehicles in a platoon can coordinate to allow other vehicles to safely enter and exit the platoon.

As another example, the vehicle can have access to a mode for racing. The logic or procedures in a racing mode can be specific to this mode for safely driving around and ahead of other vehicles along a race track. For example, while in the racing mode, the vehicle can travel at top speed at close proximity to other vehicles on the race track. In this mode, the vehicle can implement aggressive passing tactics (e.g., cutting off other vehicles at close proximities) and limit deceleration (e.g., braking). In some examples, this mode can simply record data about the vehicle and/or track that can be transferred to a computer for future use by a race crew.

It should be appreciated that in some embodiments a learning algorithm can be implemented such as a neural network (deep or shallow, which may employ a residual learning framework) and be applied instead of, or in conjunction with, another algorithm described herein to create additional modes or to improve the above-described modes and/or transitions between modes. Such learning algorithms may implement a feedforward neural network (e.g., a convolutional neural network) and/or a recurrent neural network, with structured learning, unstructured learning, and/or reinforcement learning. In some embodiments, backpropagation may be implemented (e.g., by implementing a supervised long short-term memory recurrent neural network, or a max-pooling convolutional neural network which may run on a graphics processing unit). Moreover, in some embodiments, unstructured learning methods may be used to improve structured learning methods. Moreover still, in some embodiments, resources such as energy and time may be saved by including spiking neurons in a neural network (e.g., neurons in a neural network that do not fire at each propagation cycle).

FIG. 4 illustrates an exemplary block diagram of modes that perform automated driving operations within the semi-automated level (e.g., as described above with reference to FIGS. 1-2) according to examples of the disclosure. Each of modes 402 and 404 correspond to the same set of driving logic or procedures for controlling the vehicle as modes 302 and 304 (e.g., as described above with reference to FIG. 3). Further, any mode described above (including any created modes) with reference to the fully automated level of FIG. 3 can be incorporated into the semi-automated level. In the semi-automated mode, however, the transitions from lane-following mode 402 to other modes can be manually triggered while the transitions out of those other modes (and into another mode such as mode 402) can be manually or automatically (e.g., based on certain criteria associated with that other mode) triggered. For example, while operating in mode 402, the driver can manually invoke the transition away from operating in mode 402 and into mode 404 to change lanes or pass another vehicle on the road. For another example, mode 404 can be associated with a set of criteria for transitioning out of mode 404 (e.g., criteria that is satisfied when information about the vehicle's surroundings indicates that the vehicle should not remain in mode 404), such that if, while operating in mode 404, the vehicle determines that the set of criteria associated with mode 404 is satisfied (e.g., the vehicle successfully changed lanes or passed another vehicle), it automatically (e.g., without driver input) initiates operations to transition away from operating in mode 404 and into another mode (e.g., mode 402). Other modes (e.g., the other modes described with reference to FIG. 3) can similarly be incorporated into the semi-automated level and can be associated with criteria for transitioning out of those modes (e.g., successful completion of the driving operation(s)). The semi-automated level has a lower level of autonomy than the fully automated level because of the manual triggers between modes.

FIG. 5 illustrates an exemplary block diagram of modes that perform automated driving operations within the assisted level (e.g., as described above with reference to FIGS. 1-2). Each of modes 502 and 504 correspond to a set of driving logic or procedures for controlling the vehicle while on the assisted level. For example, mode 502 can correspond to a mode for automatically (e.g., without user input) controlling the speed of the vehicle. In some examples, speed control mode 502 can implement logic or procedures for cruise control or assisted cruise control functionality while the driver manually handles steering. In some examples, speed control mode 502 can be configured to handle traffic signs or lights (e.g., by detecting traffic signs or lights through the vehicle's camera(s) and/or following the flow of traffic). For another example, mode 504 can correspond to a lane-keeping mode. In some examples, lane-keeping mode 504 can implement logic or procedures to automatically control the vehicle's steering to stay within the current lane while the driver manually handles the vehicle's speed (e.g., acceleration and deceleration). In some examples, the driver can manually activate and deactivate mode 502 or mode 504. In some examples, the assisted level can implement additional modes that can perform additional driving operations such as parallel parking. The assisted level has a lower level of autonomy than the fully automated and semi-automated levels.

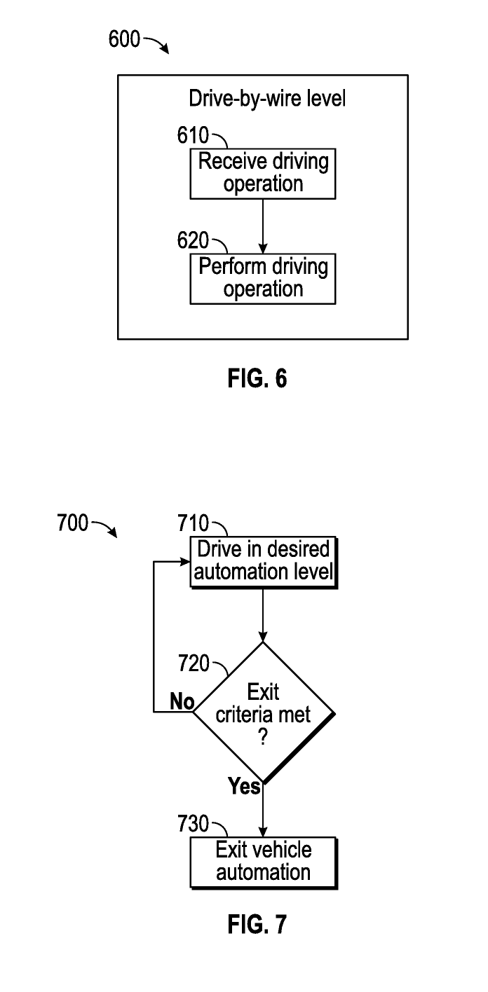

FIG. 6 illustrates an exemplary process 600 for operating a vehicle electronically within the drive-by-wire level according to examples of the disclosure. At step 610, process 600 receives a driving operation instruction from the driver. For example, process 600 can receive a steering, braking, accelerating, or any other driving operation instruction from the driver at step 610. In some examples, the driving operations can be entered through a control system such as a steering wheel, a joystick, a remote control, a pedal, a button, a touch screen, a voice command, a computer, a smartphone, or any device or system that allows user input to be entered. At step 620, the vehicle performs the driving operation instruction entered by the driver. The drive-by-wire level has the lowest level of autonomy among the fully automated, semi-automated, and assisted levels.

FIG. 7 illustrates an exemplary process 700 for controlling when process 100 exits vehicle automation step 120 (e.g., as described above with reference to FIG. 1). At step 710, process 700 periodically or continuously monitors characteristics about the vehicle surroundings, traffic information, weather information, map information, and any other information that may impede a vehicle's ability to safely navigate autonomously at any automation level (e.g., as described above with reference to FIGS. 1-6). At step 720, process 700 can determine whether the vehicle must exit vehicle automation step while operating at any automation level (e.g., as described above with reference to FIGS. 1-6). In some examples, the vehicle can make that determination based on new or missing information (e.g., missing map information) or based on any situation that the vehicle cannot handle autonomously (e.g., malfunctioning sensors or extreme weather conditions). If process 700 determines that the exit criteria are not satisfied, process 700 returns to step 710 and the vehicle continues to operate at the desired automation level (e.g., as described above with reference to FIGS. 1-6). Alternatively, if process 700 determines that the exit criteria are satisfied, process 700 exits the current automation level at step 730. This determination can cause process 100 to move out of step 120 and into step 130, 140, or 150 depending on the circumstances (e.g., as described above with reference to FIG. 1.) For example, the vehicle can be operating at the fully automated level when it enters into a construction site for which the vehicle has no map information, this can satisfy the exit criteria and the vehicle can exit the fully automated level to alert the driver before requiring the driver to take over driving operations (e.g., as described above with reference to FIG. 1). For another example, the vehicle can detect pedestrians while the vehicle is navigating itself on a highway at the semi-automated level, satisfying the exit criteria and causing the vehicle to alert the driver before requiring the driver to take over driving operations. In some examples, the criteria to exit vehicle automation and allow the driver to manually take over driving operation or disable the vehicle (e.g., as described above with reference to FIG. 1) may be satisfied with the driver manually invoking the transition. In some examples, the driver can manually invoke the transition from automation step 120 to either manual step 140 or disable step 150 of process 100 (e.g., as described above with reference to FIG. 1) through a control system such as a button, a touch screen, a voice command, a computer, a smartphone, or any device or system that allows user input to be entered. In some examples, the criteria to exit vehicle automation and disable the vehicle (e.g., as described above with reference to FIG. 1) from any automation level is satisfied when the vehicle reaches its destination.

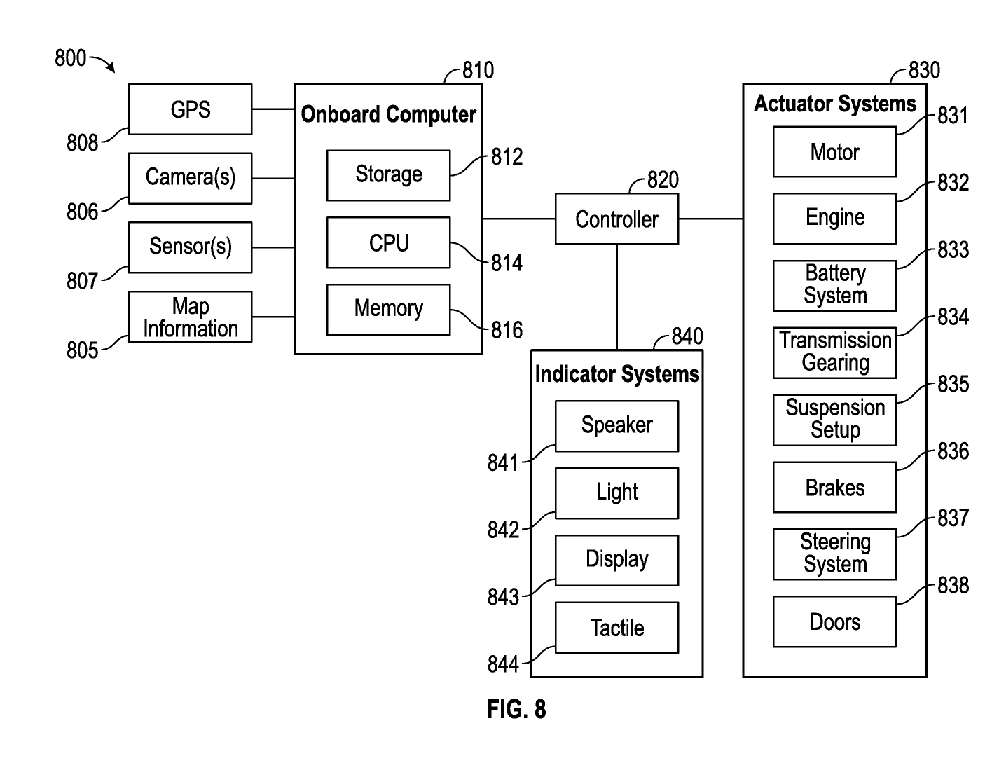

FIG. 8 illustrates an exemplary system block diagram of vehicle control system 800 according to examples of the disclosure. Vehicle control system 800 can perform any of the methods described with reference to FIGS. 1-7. System 800 can be incorporated into a vehicle, such as a consumer automobile. Other examples of vehicles that may incorporate the system 800 include, without limitation, airplanes, boats, or industrial automobiles. Vehicle control system 800 can include one or more cameras 806 capable of capturing image data (e.g., video data) for determining various characteristics of the vehicle's surroundings, as described above with reference to FIGS. 1-7. Vehicle control system 800 can also include one or more other sensors 807 (e.g., radar, ultrasonic, or LIDAR) capable of detecting various characteristics of the vehicle's surroundings, and a GPS receiver 808 capable of determining the location of the vehicle. In some examples, sensor data can be fused together. This fusion can occur at one or more electronic control units (ECUs) (not shown). The particular ECU(s) that are chosen to perform data fusion can be based on an amount of resources (e.g., processing power and/or memory) available to the one or more ECUs, and can be dynamically shifted between ECUs and/or components within an ECU (since an ECU can contain more than one processor) to optimize performance. Vehicle control system 800 can also receive information via an internet connection, such as map information via a map information interface 805 (e.g., a cellular Internet interface or a Wi-Fi Internet interface). Vehicle control system 800 can include an on-board computer 810 that is coupled to the cameras 806, sensors 807, GPS receiver 808, and map information interface 805, and that is capable of receiving the image data from the cameras and/or outputs from the sensors 807, the GPS receiver 808, and the map information interface 805. On-board computer 810 can be capable of determining whether and how to transition between driving modes or automation levels of the vehicle, as described in this disclosure. On-board computer 810 can include storage 812, memory 816, and a processor 814. Processor 814 can perform any of the methods described with reference to FIGS. 1-7. Additionally, storage 812 and/or memory 816 can store data and instructions (such as settings of various systems of the vehicle in a particular automation layer or driving mode and conditions for transitioning among the automation levels or driving modes) for performing any of the methods described with reference to FIGS. 1-7. Storage 812 and/or memory 816 can be any non-transitory computer readable storage medium, such as a solid-state drive or a hard disk drive, among other possibilities. The vehicle control system 800 can also include a controller 820 capable of controlling one or more aspects of vehicle operation, such as performing autonomous or semi-autonomous driving maneuvers based on the driving mode or automation level determinations made by the on-board computer 810.

In some examples, the vehicle control system 800 can be connected (e.g., via controller 820) to one or more actuator systems 830 in the vehicle and one or more indicator systems 840 in the vehicle. The one or more actuator systems 830 can include, but are not limited to, a motor 831 or engine 832, battery system 833, transmission gearing 834, suspension setup 835, brakes 836, steering system 837, and door system 838. The vehicle control system 800 can control, via controller 820, one or more of these actuator systems 830 during vehicle operation; for example, to open or close one or more of the doors of the vehicle using the door actuator system 838, to control the vehicle during autonomous driving or parking operations, which can utilize the automation level or driving mode determinations made by the on-board computer 810, using the motor 831 or engine 832, battery system 833, transmission gearing 834, suspension setup 835, brakes 836, and/or steering system 837, etc. The one or more indicator systems 840 can include, but are not limited to, one or more speakers 841 in the vehicle (e.g., as part of an entertainment system in the vehicle), one or more lights 842 in the vehicle, one or more displays 843 in the vehicle (e.g., as part of a control or entertainment system in the vehicle), and one or more tactile actuators 844 in the vehicle (e.g., as part of a steering wheel or seat in the vehicle). The vehicle control system 800 can control, via controller 820, one or more of these indicator systems 840 to provide indications to a driver of the vehicle of the automation level or driving mode determinations made by the on-board computer 810 (e.g., to alert the driver to take control of the vehicle if the on-board computer determines that conditions in the vehicle's surroundings warrant driver intervention). For example, on-board computer 810 can store in its memory 816 driving mode 302 which includes particular settings of how the controller 820 controls the motor 831, battery system 833, transmission gearing 834, suspension 835, brakes 836, steering system 837, etc., when the vehicle is in driving mode 302. Similarly, on-board computer 810 can also include in its memory 816 program logic that determines whether to switch to a different driving mode or automation level when the processor receives inputs from one or more of the cameras 806, sensors 806, GPS receiver 808, and/or map information 805. When certain conditions are met, as described in this disclosure, on-board computer 810 can instruct the controller 820 to set the actuator systems 830 into a setting corresponding to the new driving mode or automation level. On-board computer 810 can also receive inputs from the cameras 806, sensors 806, GPS receiver 808, and/or map information 805, and control the actuator systems 830 while the vehicle is in a particular driving mode.

Thus, the examples of the disclosure provide various ways to operate a vehicle in accordance with predefined automation levels corresponding to a plurality of driving modes and different conditions in the vehicle's surroundings.

Therefore, according to the above, some examples of the disclosure are directed to a system comprising: one or more processors; and a memory including instructions, which when executed by the one or more processors, cause the one or more processors to perform a method comprising: operating a vehicle in a first automation level, the first automation level corresponding to a first plurality of modes for operating the vehicle, the first plurality of modes comprising logic for performing one or more automated driving operations, wherein the first automation level is associated with a first logic for transitioning between the first plurality of modes; while operating the vehicle in the first automation level, determining that automation level change criteria for transitioning from the first automation level to a second automation level, different from the first automation level, are satisfied; and in response to the determination, operating the vehicle in the second automation level, the second automation level corresponding to a second plurality of modes for operating the vehicle, the second plurality of modes comprising logic for performing one or more automated driving operations, wherein the second automation level is associated with a second logic, different from the first logic, for transitioning between the second plurality of modes. Additionally or alternatively to one or more of the examples disclosed above, in some examples, determining that the automation level change criteria for transitioning from the first automation level to the second automation level are satisfied is based on driver input. Additionally or alternatively to one or more of the examples disclosed above, in some examples, determining that the automation level change criteria for transitioning from the first automation level to the second automation level are satisfied is based on map information. Additionally or alternatively to one or more of the examples disclosed above, in some examples, determining that the automation level change criteria for transitioning from the first automation level to the second automation level are satisfied is based on characteristics in the vehicle's surroundings. Additionally or alternatively to one or more of the examples disclosed above, in some examples, in response to the determination that the automation level change criteria for transitioning from the first automation level to the second automation level are satisfied, notifying the driver of the determination. Additionally or alternatively to one or more of the examples disclosed above, in some examples, the driver confirms or rejects operating the vehicle in the second automation level. Additionally or alternatively to one or more of the examples disclosed above, in some examples, the first logic for transitioning between the first plurality of modes comprises logic for automatic transitions between the first plurality of modes; and the second logic for transitioning between the second plurality of modes comprises logic for automatic and manual transitions between the second plurality of modes. Additionally or alternatively to one or more of the examples disclosed above, in some examples, the first logic and the second logic for automatic transitions are based on characteristics in the vehicle's surroundings; and the second logic for manual transitions are based on driver input. Additionally or alternatively to one or more of the examples disclosed above, in some examples, the first logic for transitioning between the first plurality of modes comprises logic for automatic transitions between the first plurality of modes based on characteristics in the vehicle's surroundings; and the second logic for transitioning between the second plurality of modes comprises logic for manual transitions between the second plurality of modes based on driver input. Additionally or alternatively to one or more of the examples disclosed above, in some examples, while operating the vehicle in the second automation level, determining that respective automation level change criteria for transitioning from the second automation level to a respective automation level are satisfied; and in accordance with a determination that the respective automation level change criteria comprise automation level change criteria for transitioning from the second automation level to a third automation level, operating the vehicle in the third automation level, different from the first and second automation levels; and in accordance with a determination that the respective automation level change criteria comprise automation level change criteria for transitioning from the second automation level to the first automation level, operating the vehicle in the first automation level. Additionally or alternatively to one or more of the examples disclosed above, in some examples, the third automation level corresponds to a third plurality of modes for operating the vehicle, the third plurality of modes comprising logic for performing one or more automated driving operations; and the third automation level is associated with a third logic, different from the first logic and the second logic, for manually transitioning between the third plurality of modes. Additionally or alternatively to one or more of the examples disclosed above, in some examples, the third automation level comprises logic for operating the vehicle through drive-by-wire driving operation instructions entered by the driver. Additionally or alternatively to one or more of the examples disclosed above, in some examples, while operating the vehicle in the respective automation level, determining that respective automation level change criteria for exiting vehicle automation are satisfied; and in accordance with a determination that the respective automation level change criteria comprise automation level change criteria for transitioning from the respective automation level to alert the driver that the vehicle is exiting vehicle automation, alerting the driver that the vehicle is exiting the respective automation level, exiting the respective automation level, and enabling the driver to manually take over driving operations after performing the alert; in accordance with a determination that the respective automation level change criteria comprise automation level change criteria for transitioning from the respective automation level to enable the driver to manually take over driving operations, exiting the respective automation level and enabling the driver to manually take over driving operations; and in accordance with a determination that the respective automation level change criteria comprise automation level change criteria for transitioning from the respective automation level to disabling the vehicle, exiting the respective automation level and disabling the vehicle. Additionally or alternatively to one or more of the examples disclosed above, in some examples, determining that the respective automation level change criteria are satisfied is based on characteristics about the vehicle's surroundings. Additionally or alternatively to one or more of the examples disclosed above, in some examples, determining that the respective automation level change criteria are satisfied is based on map information.

Some examples of the disclosure are directed to a non-transitory computer-readable medium including instructions, which when executed by one or more processors, cause the one or more processors to perform a method comprising: operating a vehicle in a first automation level, the first automation level corresponding to a first plurality of modes for operating the vehicle, the first plurality of modes comprising logic for performing one or more automated driving operations, wherein the first automation level is associated with a first logic for transitioning between the first plurality of modes; while operating the vehicle in the first automation level, determining that automation level change criteria for transitioning from the first automation level to a second automation level, different from the first automation level, are satisfied; and in response to the determination, operating the vehicle in the second automation level, the second automation level corresponding to a second plurality of modes for operating the vehicle, the second plurality of modes comprising logic for performing one or more automated driving operations, wherein the second automation level is associated with a second logic, different from the first logic, for transitioning between the second plurality of modes.

Some examples of the disclosure are directed to a vehicle comprising: one or more processors; and a memory including instructions, which when executed by the one or more processors, cause the one or more processors to perform a method comprising: operating the vehicle in a first automation level, the first automation level corresponding to a first plurality of modes for operating the vehicle, the first plurality of modes comprising logic for performing one or more automated driving operations, wherein the first automation level is associated with a first logic for transitioning between the first plurality of modes; while operating the vehicle in the first automation level, determining that automation level change criteria for transitioning from the first automation level to a second automation level, different from the first automation level, are satisfied; and in response to the determination, operating the vehicle in the second automation level, the second automation level corresponding to a second plurality of modes for operating the vehicle, the second plurality of modes comprising logic for performing one or more automated driving operations, wherein the second automation level is associated with a second logic, different from the first logic, for transitioning between the second plurality of modes.

Some examples of the disclosure are directed to a method comprising: operating a vehicle in a first automation level, the first automation level corresponding to a first plurality of modes for operating the vehicle, the first plurality of modes comprising logic for performing one or more automated driving operations, wherein the first automation level is associated with a first logic for transitioning between the first plurality of modes; while operating the vehicle in the first automation level, determining that automation level change criteria for transitioning from the first automation level to a second automation level, different from the first automation level, are satisfied; and in response to the determination, operating the vehicle in the second automation level, the second automation level corresponding to a second plurality of modes for operating the vehicle, the second plurality of modes comprising logic for performing one or more automated driving operations, wherein the second automation level is associated with a second logic, different from the first logic, for transitioning between the second plurality of modes.

Although examples have been fully described with reference to the accompanying drawings, it is to be noted that various changes and modifications will become apparent to those skilled in the art. Such changes and modifications are to be understood as being included within the scope of examples of this disclosure as defined by the appended claims.

1. A system comprising:
one or more processors; and
a memory including instructions, which when executed by the one or more processors, cause the one or more processors to perform a method comprising:
operating a vehicle in a first automation level, the first automation level corresponding to a first plurality of modes for operating the vehicle, the first plurality of modes comprising logic for performing one or more automated driving operations, wherein the first automation level is associated with a first logic for transitioning between the first plurality of modes;
while operating the vehicle in the first automation level, determining that automation level change criteria for transitioning from the first automation level to a second automation level, different from the first automation level, are satisfied; and
in response to the determination, operating the vehicle in the second automation level, the second automation level corresponding to a second plurality of modes for operating the vehicle, the second plurality of modes comprising logic for performing one or more automated driving operations, wherein the second automation level is associated with a second logic, different from the first logic, for transitioning between the second plurality of modes.

2. The system of claim 1, wherein determining that the automation level change criteria for transitioning from the first automation level to the second automation level are satisfied is based on driver input.

3. The system of claim 1, wherein determining that the automation level change criteria for transitioning from the first automation level to the second automation level are satisfied is based on map information.

4. The system of claim 1, wherein determining that the automation level change criteria for transitioning from the first automation level to the second automation level are satisfied is based on characteristics in the vehicle's surroundings.

5. The system of claim 1, wherein the method further comprises in response to the determination that the automation level change criteria for transitioning from the first automation level to the second automation level are satisfied, notifying the driver of the determination.

6. The system of claim 5, wherein the driver confirms or rejects operating the vehicle in the second automation level.

7. The system of claim 1, wherein:
the first logic for transitioning between the first plurality of modes comprises logic for automatic transitions between the first plurality of modes; and
the second logic for transitioning between the second plurality of modes comprises logic for automatic and manual transitions between the second plurality of modes.

8. The system of claim 7, wherein:
the first logic and the second logic for automatic transitions are based on characteristics in the vehicle's surroundings; and
the second logic for manual transitions are based on driver input.

9. The system of claim 1, wherein:
the first logic for transitioning between the first plurality of modes comprises logic for automatic transitions between the first plurality of modes based on characteristics in the vehicle's surroundings; and
the second logic for transitioning between the second plurality of modes comprises logic for manual transitions between the second plurality of modes based on driver input.

10. The system of claim 1, wherein the method further comprises:
while operating the vehicle in the second automation level, determining that respective automation level change criteria for transitioning from the second automation level to a respective automation level are satisfied; and
in accordance with a determination that the respective automation level change criteria comprise automation level change criteria for transitioning from the second automation level to a third automation level, operating the vehicle in the third automation level, different from the first and second automation levels; and
in accordance with a determination that the respective automation level change criteria comprise automation level change criteria for transitioning from the second automation level to the first automation level, operating the vehicle in the first automation level.

11. The system of claim 10, wherein:
the third automation level corresponds to a third plurality of modes for operating the vehicle, the third plurality of modes comprising logic for performing one or more automated driving operations; and
the third automation level is associated with a third logic, different from the first logic and the second logic, for manually transitioning between the third plurality of modes.

12. The system of claim 2, wherein the third automation level comprises logic for operating the vehicle through drive-by-wire driving operation instructions entered by the driver.

13. The system of claim 10 wherein the method further comprises:
while operating the vehicle in the respective automation level, determining that respective automation level change criteria for exiting vehicle automation are satisfied; and
in accordance with a determination that the respective automation level change criteria comprise automation level change criteria for transitioning from the respective automation level to alert the driver that the vehicle is exiting vehicle automation, alerting the driver that the vehicle is exiting the respective automation level, exiting the respective automation level, and enabling the driver to manually take over driving operations after performing the alert;
in accordance with a determination that the respective automation level change criteria comprise automation level change criteria for transitioning from the respective automation level to enable the driver to manually take over driving operations, exiting the respective automation level and enabling the driver to manually take over driving operations; and
in accordance with a determination that the respective automation level change criteria comprise automation level change criteria for transitioning from the respective automation level to disabling the vehicle, exiting the respective automation level and disabling the vehicle.

14. The system of claim 13, wherein determining that the respective automation level change criteria are satisfied is based on characteristics about the vehicle's surroundings.

15. The system of claim 13, wherein determining that the respective automation level change criteria are satisfied is based on map information.

16. A vehicle comprising:
one or more processors; and
a memory including instructions, which when executed by the one or more processors, cause the one or more processors to perform a method comprising:
operating the vehicle in a first automation level, the first automation level corresponding to a first plurality of modes for operating the vehicle, the first plurality of modes comprising logic for performing one or more automated driving operations, wherein the first automation level is associated with a first logic for transitioning between the first plurality of modes;
while operating the vehicle in the first automation level, determining that automation level change criteria for transitioning from the first automation level to a second automation level, different from the first automation level, are satisfied; and
in response to the determination, operating the vehicle in the second automation level, the second automation level corresponding to a second plurality of modes for operating the vehicle, the second plurality of modes comprising logic for performing one or more automated driving operations, wherein the second automation level is associated with a second logic, different from the first logic, for transitioning between the second plurality of modes.

17. A method comprising:
operating a vehicle in a first automation level, the first automation level corresponding to a first plurality of modes for operating the vehicle, the first plurality of modes comprising logic for performing one or more automated driving operations, wherein the first automation level is associated with a first logic for transitioning between the first plurality of modes;
while operating the vehicle in the first automation level, determining that automation level change criteria for transitioning from the first automation level to a second automation level, different from the first automation level, are satisfied; and
in response to the determination, operating the vehicle in the second automation level, the second automation level corresponding to a second plurality of modes for operating the vehicle, the second plurality of modes comprising logic for performing one or more automated driving operations, wherein the second automation level is associated with a second logic, different from the first logic, for transitioning between the second plurality of modes.
